(19) United States
(12) Patent Application Publication
(10) Pub. No.: US 2011/0031080 A1
(43) Pub. Date: Feb. 10, 2011

(54) Modular Energy Dissipation System

(75) Inventor: Francesc Xavier Cahis I Carola, Girona (ES)

Correspondence Address: ROBERTS MLOTKOWSKI SAFRAN & COLE, P.C.;Intellectual Property Department, P.O. Box 10064, MCLEAN, VA, 22102-8064, US

(73) Assignee: UNIVERSITAT DE GIRONA, Girona (ES)

(21) Appl. No.: 12/937,320

(22) PCT Filed: Apr. 8, 2009
(86) PCT No.: PCT/EP09/54266

§ 371 Date: Oct. 11, 2010

(30) Foreign Application Priority Data
Apr. 10, 2008 (ES) P200801080

(51) Int. Cl. F16F 7/12; E04B 1/98

(52) U.S. Cl. 188/371

(57) ABSTRACT

Modular energy dissipation system for linking two structures in a linking direction, comprising a yielding energy dissipator (1) provided with at least two energy dissipation modules (15, 16) successively arranged along said linking direction, each module comprising a central strip (12; 12′), two sidelong strips (13; 13′) and a plurality of yielding elements (14; 14′) between the central strip and the sidelong strips, so that the central strip of a module located at one end of the dissipator is linked to one of the structures and the sidelong strips of this module are integrated with the central strip of the adjacent module, and the sidelong strips of the module located at the other end of the dissipator are linked to the other structure and the central strip of this module is integrated with the sidelong strips of the adjacent module.

The present invention is related to a modular energy dissipation system for linking two structural members in a linking direction, comprising a yielding energy dissipator provided with a central strip, two sidelong strips and at least two yielding elements arranged at both sides of the central strip, between the latter and the two sidelong strips.

Said structural members may be parts of just one building or of different buildings, or even whole buildings. A structural member is herein defined as an object presenting a resistant functionality against the loads (gravity, wind, seism, etc) acting on a building; structural members may include masonry and installations.

### BACKGROUND ART

Various systems to reduce or avoid damage to a building or to several nearby buildings when subjected to a dynamic action (seism, wind, etc) are known. Their main aim is to control (reduce) the relative displacements taking place between structural members, which may belong to one building or to nearby buildings.

In one such system the link between two structural or constructive members is carried out by energy dissipation devices which absorb energy upon yielding, when the stress is higher than the yield point of the material. Yielding may be caused by a shear stress (shear yielding), a bending moment (flexure yielding), a torsion moment, or a combination thereof.

Said dissipators are normally elasto-plastic elements and, for instance, may belong to a structure composed of two substructures having clearly differentiated functions (for example, one substructure could bear gravitational actions and respond quite flexibly to horizontal loads, while the other substructure could respond rather rigidly to horizontal loads and be linked to the first substructure by energy dissipators).

Elasto-plastic dissipators that yield under shear stress present the advantage of having high stiffness in their elastic mode and small yielding deformation.

The thickness of their dissipative body must be small enough for the maximum force to fall within the appropriate range regarding their connective and dissipative function. It is common to weld stiffeners to the dissipators in order to prevent web buckling from appearing, but welded junctions can have adverse effects, like brittle behavior, which are enhanced with thin webs.

A shear yield dissipator (also known as shear link dissipator) without welding in the deforming areas is already known (Cahís, X., Torres, L I. And Bozzo, L., “An innovative elasto-plastic energy dissipator for the structural and non-structural building protection”, 2000, Proceedings of the 12^{th} World Conference on Earthquake Engineering, Auckland, New Zealand), allowing the design of dissipators having a thin web that can be fabricated with milling machines. Such a dissipator has a relatively thin dissipative body with a double-T shaped cross-section, the web of which is stiffened to prevent buckling. Energy dissipation takes place by virtue of plastic deformation due to shear stress in the dissipative body web, because of the relative displacement between two plates welded above and below the dissipative body and arranged perpendicularly thereto.

The small web thickness allows the web to start deforming before the areas near the plates do, whereby the plastic deformability (i.e., the energy dissipation) of the dissipator can be increased in spite of the reduced relative displacement between the plates. The plates and the stiffeners are incorporated by welding, which makes its manufacture more complicate, and the plates increase the flexibility of the dissipator, which is not desirable. The stiffeners are necessary because of the web thinness (the web thickness is small compared to the web size as taken on the dissipator plane).

Patent U.S. 4,959,934 discloses a prism-shaped or bock-like elasto-plastic dissipator having two groups of holes, one to each side of a central strip of the dissipator. In one embodiment two of said dissipators are linked through their upper and lower ends (above and below the central strip) by brackets that in turn are fastened by welding to a pillar interposed between the dissipators; the two dissipators are linked to respective beams through their central strips, and are intended to attenuate the horizontal displacement between the pillar and the beams.

### SUMMARY OF THE INVENTION

It is an object of the present invention to provide an energy dissipator not requiring stiffeners, the basic design of which being easily adaptable in order to be able to absorb different amounts of energy or to yield when subjected to forces of different magnitude. Another object is to allow the manufacture of the dissipator to be automated.

According to one aspect of the invention, the dissipator comprises at least two energy dissipation modules successively arranged along the linking direction, each module being provided with the central strip, sidelong strips and yielding elements, so that the central strip of a module located at one end of the dissipator is linked to one of the structural members and the sidelong strips of this module are integrated with the central strip of the adjacent module.

The sidelong strips of the module located at the other end of the dissipator are linked to one of the structural members and the central strip of this module is integrated with the sidelong strips of the adjacent module.

In an embodiment, the dissipator comprises at least three such modules.

With the modular system comprising an elongated dissipator as described above, made in one piece with each module longitudinally integrated with the adjacent modules, said piece being relatively small (since each module does not have to be big), a bigger displacement is achieved with the same force because each module is subjected to the same force than the dissipator as a whole, but the displacement of the dissipator is the sum of the displacement of all modules, whereby the dissipator is capable of dissipating more energy. This is so because of the junction between the central strip of a module and the sidelong strips of an adjacent module, and vice versa, which allows a relative displacement in each module between its central strip and its sidelong strips.

The fact of the dissipator being one piece allows manufacturing it by machining (either by cutting swarf or without cutting swarf), particularly by milling. The number or the geometry of each module's yielding elements can be varied in order for yielding to take place in response to different forces.

The yielding elements of a module can yield mainly under shear stress or mainly under flexure stress; what matters is for yielding to take place upon a predictable force and a predictable displacement.

An advantageous way of manufacturing the dissipator is by milling a plate or a profile having a rectangular cross-section; such operation can be automated.

When yielding is under shear stress, it is preferred for the yielding elements of at least one module to comprise a region thinner than the dissipator's plate; yielding takes place in this region.

When yielding is under flexure stress, it is preferred for the yielding elements of at least one module to comprise at least one plate of variable cross-section, since such a variable cross-section can be adjusted to the bending moment to which each section is subjected.

In an embodiment, the yielding elements of at least one module comprise a through hole, whereby yielding takes place under shear stress or under flexure stress depending on the geometry of the hole: when the height of the hole is small as compared to its width shear yielding will prevail, and when the hole is relatively tall flexure yielding will prevail.

The dissipator is linked at both ends to the structural members through a first connector and a second connector, which are substantially aligned along the linking direction.

Advantageously, the second connector comprises two Ω-shaped profiles joined through their flanges, and the first connector comprises two U-shaped profiles that are housed in corresponding axial spaces defined inside the Ω-shaped profiles of the second connector. In this way, when the dissipator yields the first connector can move inside the second connector.

In an embodiment, the dissipator is arranged between said two Ω-shaped profiles of the second connector and, consequently, also between said two U-shaped profiles of the first connector.

Preferably, the first connector is linked to the dissipator at one end and through the central strip thereof, and the second connector is linked to the dissipator at the other end and through the sidelong strips thereof, so that the maximum profit from the geometry of the connectors is derived.

In an embodiment, two dissipators are arranged between the structural elements, one dissipator being linked to each end of the second connector and the dissipators being linked to said structural members through two corresponding first connectors.

### BRIEF DESCRIPTION OF THE DRAWINGS

Some particular embodiments of the present invention will be described in the following, only by way of non-limiting example, with reference to the appended drawings, in which:

FIG. 1 is a schematic elevation view of a basic dissipation module;

FIG. 2 is a schematic elevation view of a dissipator comprising two modules;

FIG. 3 is an elevation view of a dissipator comprising a shear yield dissipation module;

FIG. 4 is a cross-section view taken on the plane 4-4 of FIG. 3;

FIG. 5 is a cross-section view taken on the plane 5-5 of FIG. 3;

FIG. 6 is an elevation view of another dissipator comprising a shear yield dissipation module;

FIG. 7 is a partly cut-out perspective view of the dissipator of FIG. 3 linked to two connectors;

FIG. 8 is like FIG. 7 but not cut-out;

FIG. 9 is an elevation view of a structure with the dissipator and the connectors of FIGS. 7 and 8;

FIG. 10 is like FIG. 9 but with the structure being subjected to a relative displacement between floors causing the connectors to be pushed and the dissipator to yield;

FIG. 11 is like FIG. 9 but with the structure being subjected to a relative displacement between floors causing the connectors to be pulled and the dissipator to yield;

FIG. 12 is a view of the dissipator of FIG. 3 after yielding with the connectors pushing;

FIG. 13 is a view of the dissipator of FIG. 3 after yielding with the connectors pulling;

FIG. 14 is an elevation view of a dissipator comprising more yielding elements;

FIG. 15 is an elevation view of a dissipator comprising two modules;

FIG. 16 is a view of the dissipator of FIG. 15 after yielding with the connectors pushing;

FIG. 17 is a view of the dissipator of FIG. 15 after yielding with the connectors pulling;

FIG. 18 is an elevation view of a dissipator comprising three modules;

FIG. 19 shows different arrangements of a dissipator and the connectors;

FIG. 20 is a perspective view of a dissipator linked to some connectors;

FIG. 21 is a perspective view of the dissipator of FIG. 20;

FIG. 22 is an elevation view of the dissipator of FIG. 21;

FIG. 23 is perspective view of an element of FIG. 20; and

FIG. 24 is a perspective view of another element of FIG. 20.

### DESCRIPTION OF PARTICULAR EMBODIMENTS

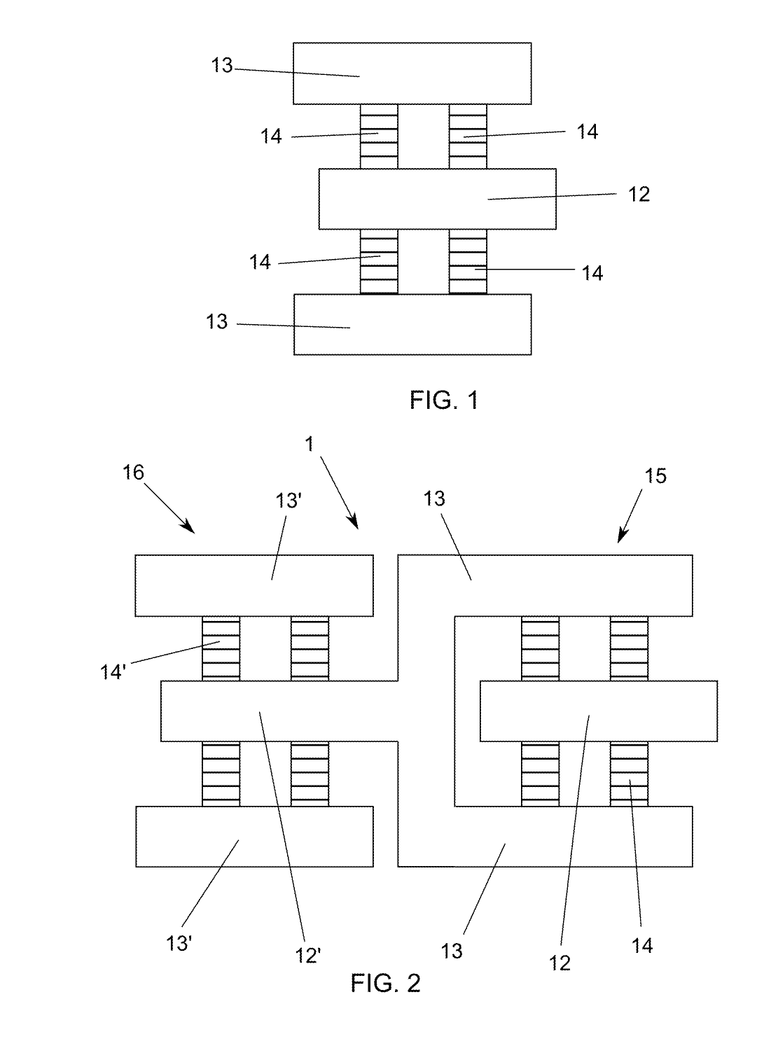

FIG. 1 schematically shows a basic dissipation module comprising a central strip 12 having a main direction substantially coincident with the linking direction to the two structural members, two sidelong strips 13 arranged along each side of (or above and below) the central strip 12 and having the same main direction thereof, and four yielding elements 14 symmetrically arranged between the central strip and the sidelong strips.

The yielding elements 14 are the basic elements which yield when the elements linking the dissipator to the structural members undergo a relative displacement important enough; this yielding provides the energy dissipation necessary to absorb the energy of the displacement. The yielding elements 14 yield mainly under shear stress or mainly under flexure stress; in the latter case they absorb bending moments and usually comprise some thin plates having a constant thickness and a variable cross-section (like for instance the dissipator known as ADAS). The following description will focus mainly on dissipators provided with shear yield elements 14.

FIG. 2 shows a dissipator 1 comprising two modules 15 and 16 each of which is like the basic module of FIG. 1. The two modules are linked by integrating the central strip 12′ of module 16 and the sidelong strips 13 of module 15. With this arrangement the central strip 12 of module 15 is linked to one structure and the sidelong strips 13′ of module 16 are linked to the other structure. In this way the dissipative capacity of the dissipator is doubled, because the same force produces a twofold displacement during the deformation of the dissipator. Generally speaking, in a dissipator comprising N modules the dissipated energy is N times the energy dissipated in one module, and the displacement is increased N-fold too.

On the other hand, a basic dissipation module may comprise more or less yielding elements 14, and this possibility allows the yielding force of the module, and hence that of the dissipator, to be adapted to the necessities of the structure while keeping the deformability equal to that of the yielding element.

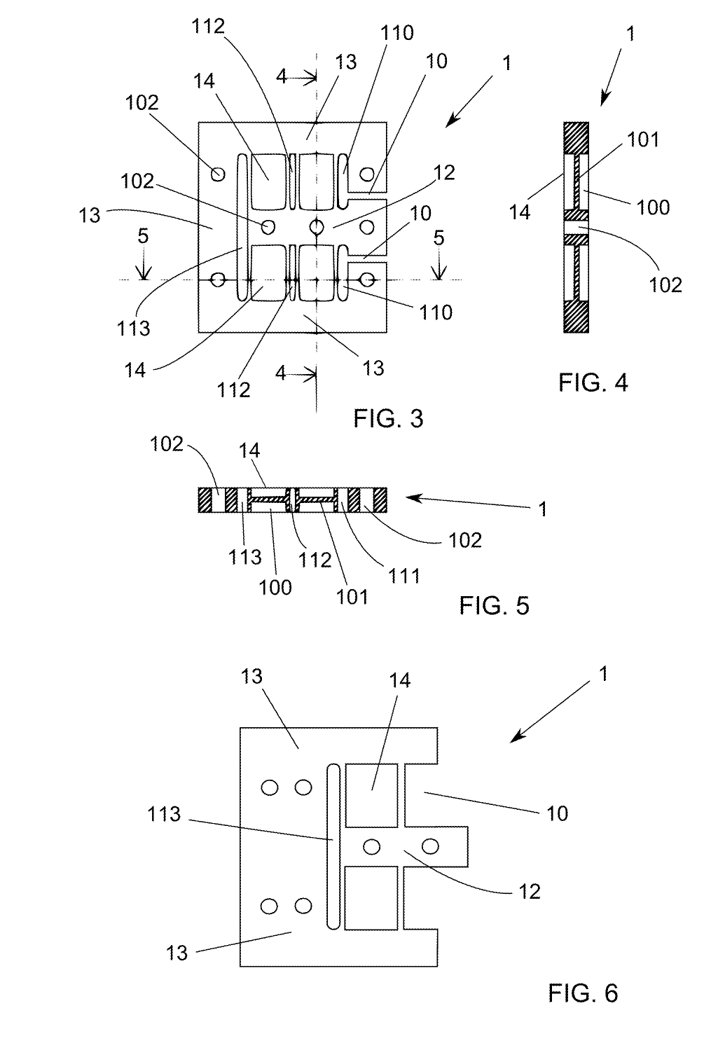

FIG. 3 shows a dissipator 1 comprising just one module and being a particular embodiment of the module of FIG. 1; the same reference numerals denote analogous elements: central strip 12, sidelong strips 13 and yielding elements 14. The yielding elements 14 comprise some recesses or concavities 100 and, between them, a narrower partition or thin wall 101 which is the region that yields (see FIGS. 4 and 5).

The central strip 12 reaches an elongate hole 113 (herein a hole means a through hole) extending perpendicularly to the linking direction. The strip lying behind the elongate hole 113 and being substantially perpendicular to the central strip 12 joins the two sidelong strips 13 and is functionally integrated with them, because it serves to link the dissipator module at that end, whereas the central strip 12 serves to link the module at the opposite end.

The dissipator of FIG. 3 comprises two cuts 10 at both sides of the outer end of the central strip 12. The dissipator 1 also comprises two elongate holes 112 which are parallel to the elongate hole 113 and are located between two yielding elements 14. The cuts 10 are prolonged into two elongate holes 110 which are similar to the elongate holes 112.

The dissipator 1 also comprises a plurality of holes 102 to link the dissipator to the two structures by means of bolts and nuts or any equivalent elements.

FIG. 6 shows a dissipator comprising just one module similar to that of FIG. 3 but having two yielding elements 14 instead of four, and in which the cuts 10 and the corresponding holes 110 are outwardly opened.

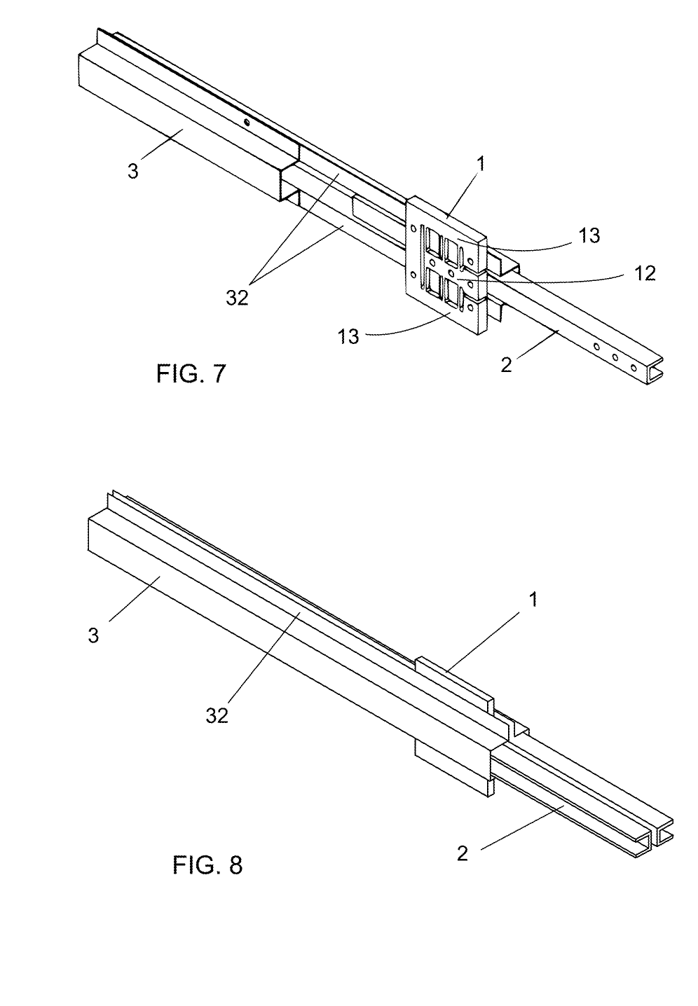

FIG. 7 shows a possible way of linking the dissipator of FIG. 3, although it can also be applied to any dissipator according to the present invention. Said connection comprises a first connector 2 and a second connector 3. In FIG. 7 the first connector 2 is an U-shaped bar and the second connector 3 comprises two 0-shaped profiles joined through their flanges 32, so that the first connector 2 can be housed within the second connector 3. The two connectors are aligned along the direction linking the dissipator to the two structures.

Actually, the connectors shown in FIG. 7 are cut-out in order to better understand the assembly. FIG. 8 shows the complete connectors. As can be seen, the two profiles of connector 3 are linked to dissipator 1, one on each face thereof, and connector 2 comprises two U-shaped profiles joined through their backs that are also linked to dissipator 1, one on each face too. However, the connections shown in FIG. 7 are feasible as well.

As can be seen in FIG. 7, the first connector 2 is linked through its base to the central strip 12 of dissipator 1, and the second connector 3 is linked through its flanges 32 to the sidelong strips 13 of dissipator 1. When the dissipator yields the first connector 2 moves inside the second connector 3; the tolerance between the two connectors is positive and the play between them is big enough for this movement to be possible, but it is also small enough for ensuring the stability of the assembly of the dissipator and the connectors, because the three of them must be kept aligned, both when the dissipator is pulled and when it is pushed.

The tolerance between the dissipator 1 and the flanges 32 is positive too, in order to allow the movement of the dissipator when it is yielding.

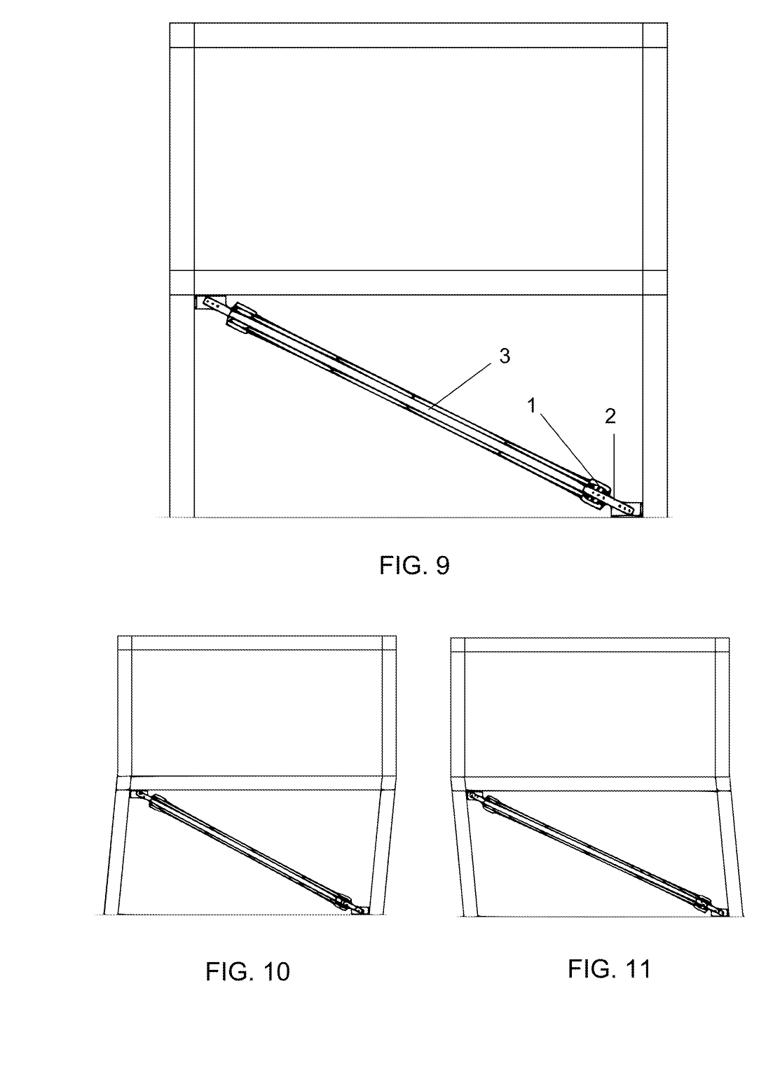

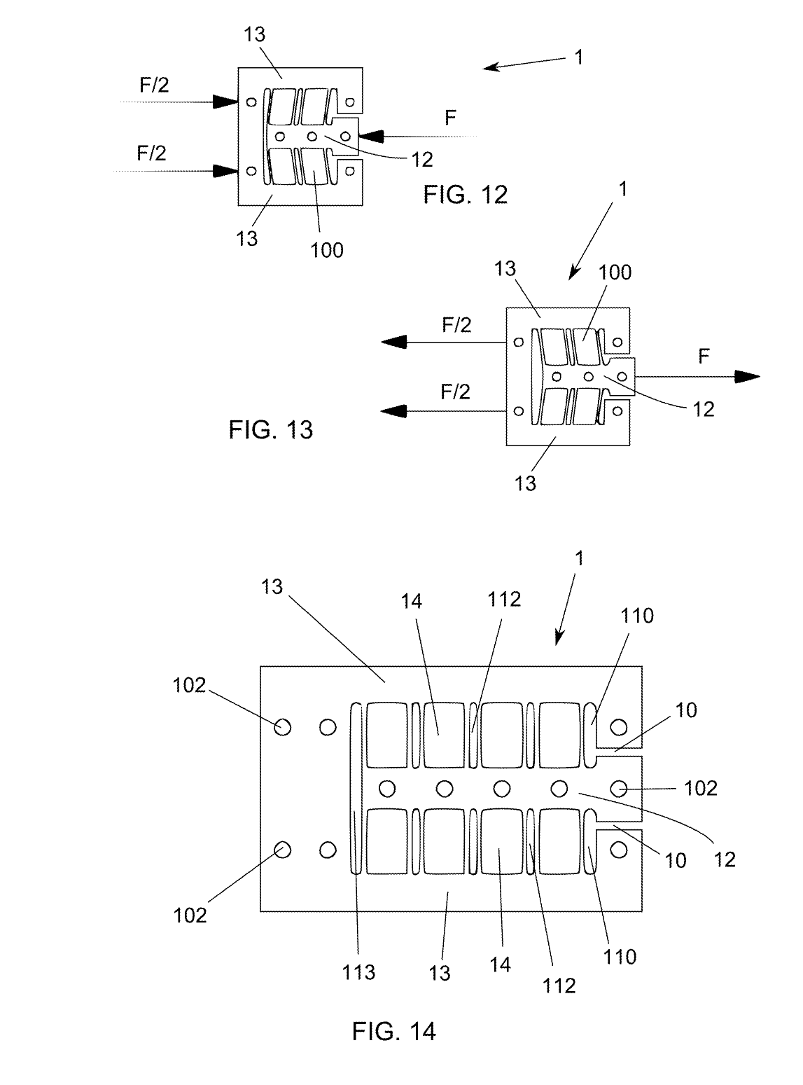

FIG. 9 shows an application of the dissipator 1 and the connectors 2 and 3 in a frame, specifically on a diagonal thereof, in order to limit the horizontal displacement between the frame floors, and FIGS. 10 and 11 show, exaggeratedly, two instances of said horizontal displacement. Upon the displacement of FIG. 10 the dissipator yields pushed by the connectors and upon the displacement of FIG. 10 the dissipator yields pulled by the connectors. Precisely FIG. 12 shows, likewise exaggeratedly, the dissipator 1 after yielding when pushed by the connectors and FIG. 13 shows the dissipator after yielding when pulled by the connectors.

The arrangement of FIG. 9 may be provided with two dissipators linked to both ends of the second connector 3 and to the structural members through two first connectors 2, which are then connected to both ends of the frame diagonal.

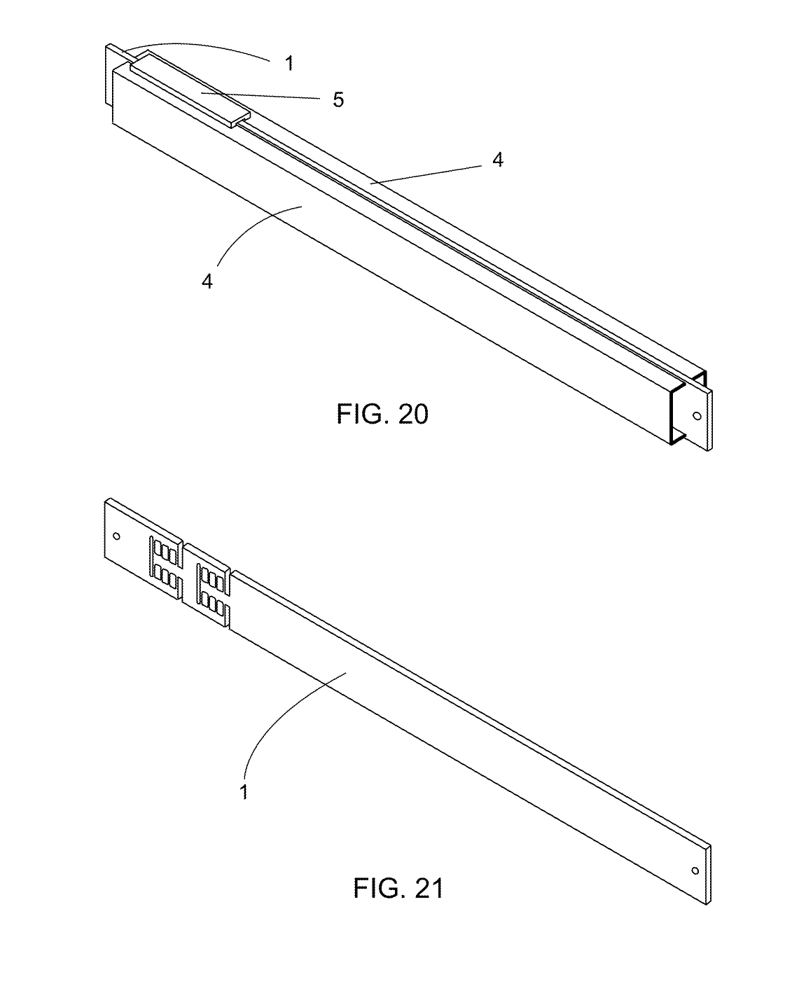

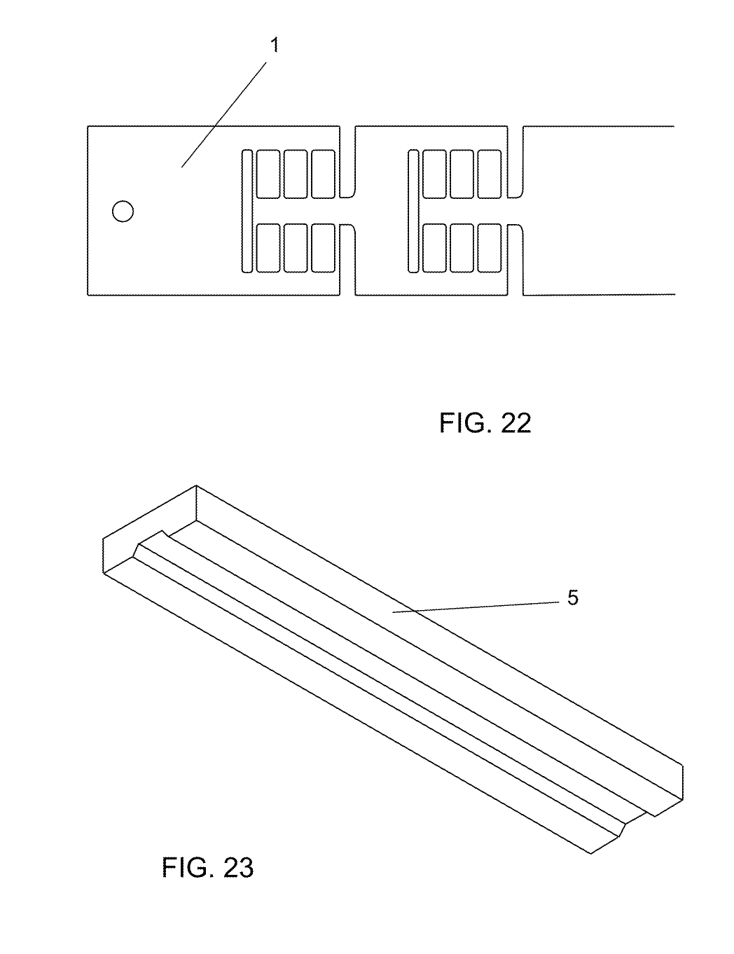

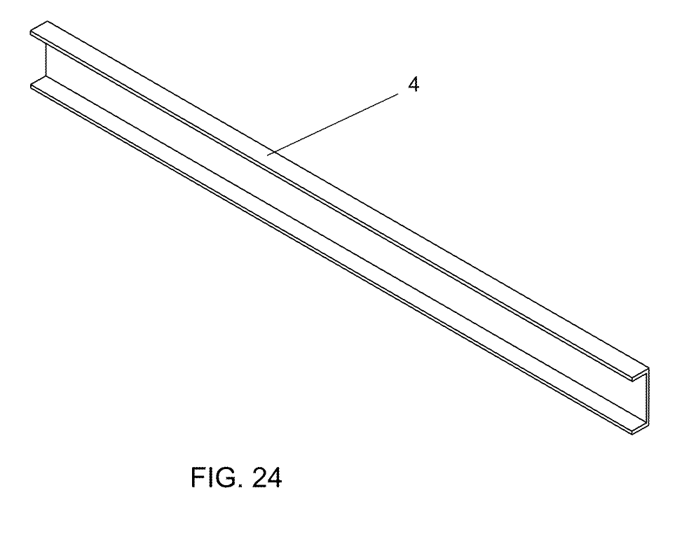

FIG. 20 shows a linking arrangement similar to that of FIGS. 7 and 8 but without separate connectors. In this arrangement the dissipator 1 is an elongate plate comprising one or more dissipation modules (see FIGS. 21 and 22), said elongate plate also playing the role of a connector for linking the dissipator to two structures. Two U-shaped profiles 4 (also shown in FIG. 24) are welded or likewise attached to the dissipator 1, at both faces thereof, in order to stiffen it to prevent buckling; the profiles 4 are not attached to the dissipator 1 at the regions comprising the dissipation modules, so as not to impair yielding.

An U-shaped stiffener 5 (also shown in FIG. 23) is located at one end region of the dissipator 1 and is welded or likewise attached to both profiles 4, bridging over the dissipator 1; it can also be placed at the other end region thereof.

The dissipation modules of the dissipator 1 can be located at any longitudinal region thereof. Instead of being directly linked to both structures, the dissipator 1 could be linked to one structure by means of connectors 2 or 3 like those of FIGS. 7 and 8.

FIGS. 12 and 13 show the functionality of recesses 100 and elongate holes to achieve plastic deformation in the regions between the central strip and the sidelong strips. Thanks to the fact that one of the connectors 2 and 3 are linked to the central strip 12 of the dissipator, that the other connector is linked to the sidelong strips 13, and that recesses 100 are located between the central strip and the sidelong strips, a double yielding deformation takes place when the central strip is displaced with respect to the sidelong strips (in this embodiment the yielding is a shear yielding, but in other embodiments it could be a flexure yielding).

FIG. 14 shows another embodiment of dissipator 1 comprising a higher number of yielding elements 14 and elongate holes 112. Increasing the number of yielding elements has the effect of increasing the yielding force of the dissipator or of the dissipation module. The dissipator of FIG. 14 logically comprises more linking holes 102 in order to support a bigger axial force.

FIG. 15 shows a dissipator 1 having two dissipation modules 15 and 16 arranged one after another in the linking direction. This dissipator is a specific embodiment of the schematic dissipator shown in FIG. 2. The two modules 15 and 16 are analogous to the dissipator of FIG. 3. As with the dissipator of FIG. 2, the central strip 12′ of module 16 is joined to the sidelong strips 13 of module 15, in this case through a tab 19 integrating said central strip 12′ of module 16 with the sidelong strips 13 of module 15. As in FIG. 2, the central strip 12 of module 15 is linked to one structural member and the sidelong strips 13′ of module 16 are linked to the other structural member. The cuts 10 at the end of the central strip 12′ are extended by corresponding perpendicular cuts separating the two modules.

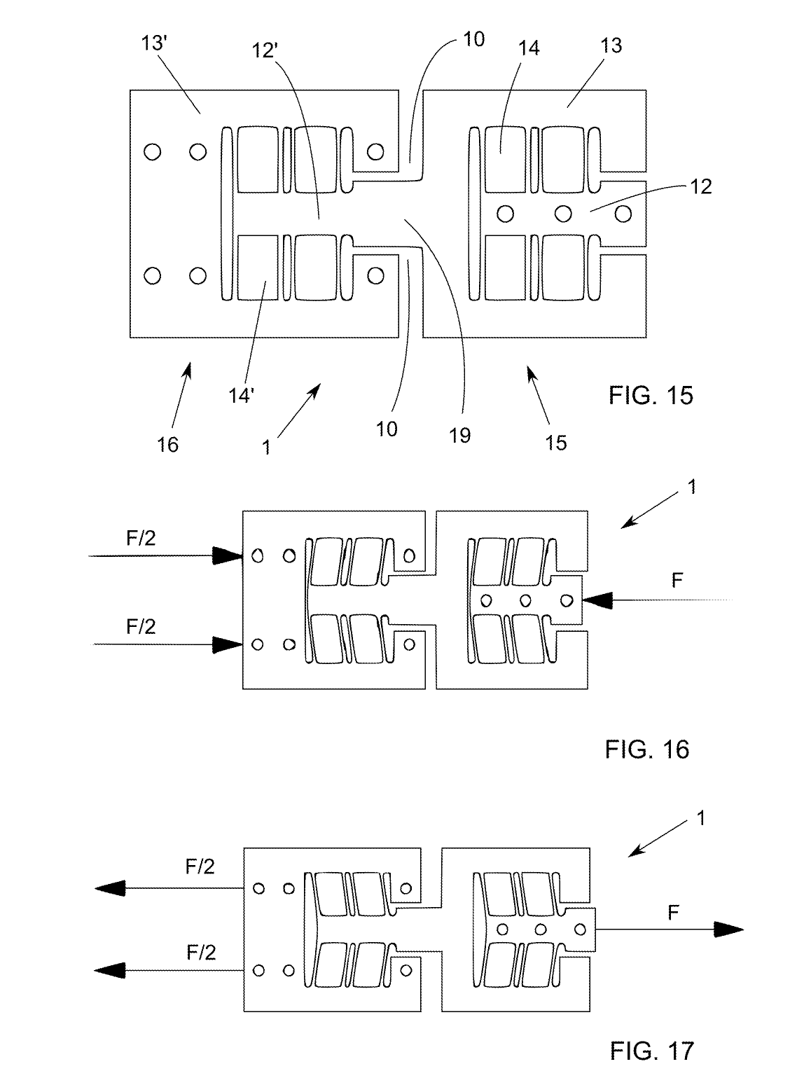

FIGS. 16 and 17 show the dissipator of FIG. 15 after yielding when pushed or pulled, respectively, by the connectors.

All the embodiments of the dissipator 1 are made in one piece and can be machined with cutting tools either by cutting swarf or without cutting swarf, particularly by milling, and its manufacture can be automated by employing CAD-CAM methods. The dissipator can be made from steel or any other metal suitable for plastic deformation.

Although only particular embodiments of the invention have been shown and described in the present specification, the skilled man will be able to introduce modifications and substitute any technical features thereof with others that are technically equivalent, depending on the particular requirements of each case, without departing from the scope of protection defined by the appended claims.

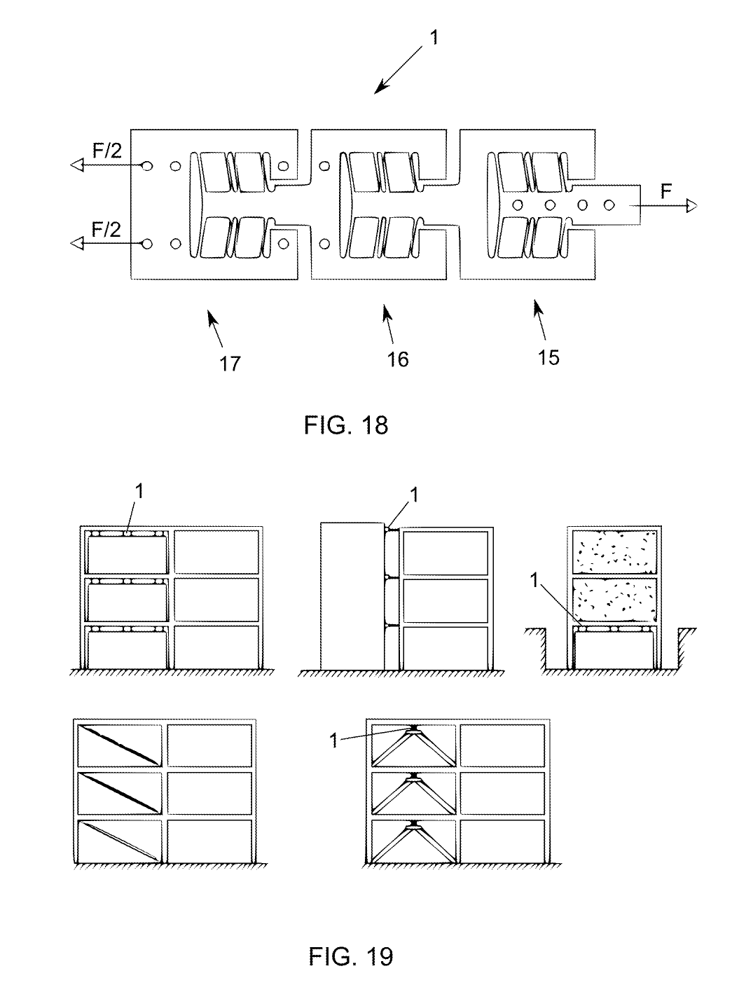

For example, a dissipator 1 according to the invention may comprise any number of modules (FIG. 18 shows a dissipator having three modules). It is not necessary that all the modules are equal, but it is necessary that all of them yield under substantially the same force.

Although the dissipator shown in the drawings is plate-like, it can also be block-like.

1. A modular energy dissipation system for linking two structural members in a linking direction, comprising a yielding energy dissipator provided with a central strip, two sidelong strips and at least two yielding elements arranged at both sides of the central strip, between the central strip and the two sidelong strips, the dissipator further comprising at least two energy dissipation modules successively arranged along said linking direction, each module being provided with:
said central strip, two sidelong strips and at least two yielding elements, so that the central strip of one module located at one end of the dissipator is linked to one of the structural members and the two sidelong strips of said one module are integrated with the central strip of an adjacent module.

2. A system according to claim 1, wherein the sidelong strips of a different module, located at the other end of the dissipater are linked to one of the structural members and the central strip of such different module is integrated with the sidelong strips of an adjacent module.

3. A system according to claim 1, wherein the dissipator is a machined plate.

4. A system according to claim 3, wherein the yielding elements of at least one module comprise a region thinner than the machined plate.

5. A system according to claim 3, wherein the yielding elements of at least one module comprise at least one plate of variable cross-section.

6. A system according to claim 3, wherein the yielding elements of at least one module comprise a through hole.

7. A system according to claim 1, wherein the dissipator is made of one piece.

8. A system according to claim 7, wherein the dissipator is an elongate plate stiffened by two U-shaped profiles attached to both faces thereof, except at the regions comprising the at least two energy dissipation modules, so as not to impair yielding.

9. A system according to claim 8, comprising an U-shaped stiffener located at one end region of the dissipator and attached to both U-shaped profiles, bridging over the dissipator.

10. A system according to claim 1, wherein the dissipator comprises at least three energy dissipation module.

11. A system according to claim 2, wherein the dissipator is linked at both ends to the structural members through a first connector and a second connector, which are substantially aligned along the linking direction.

12. A system according to claim 11, wherein the second connector comprises two Ω-shaped profiles joined through their flanges, and the first connector comprises two U-shaped profiles that are housed in corresponding axial spaces defined inside the Ω-shaped profiles of the second connector.

13. A system according to claim 12, wherein the dissipator is arranged between said two Ω-shaped profiles of the second connector and, consequently, also between the two U-shaped profiles of the first connector.

14. A system according to claim 11, wherein the first connector is linked to the dissipator at one end and through the central strip thereof, and the second connector is linked to the dissipator at the other end and through the sidelong strips thereof.

15. A system according to claim 14, wherein two dissipators are arranged between the structural elements, one dissipator being linked to each end of the second connector and the dissipators being linked to said structural members through two corresponding first connectors.
